(19) United States
(12) Patent Application Publication
(10) Pub. No.: US 2019/0325851 A1
(43) Pub. Date: Oct. 24, 2019

(54) MULTI EFFECT GUITAR PICK WITH GRIP CREATING NEW SOUNDS

(71) Applicant: Gary Richard, Danvers, MA (US)

(72) Inventor: Gary Richard, Danvers, MA (US)

(21) Appl. No.: 16/389,983

(22) Filed: Apr. 21, 2019

Related U.S. Application Data
(60) Provisional application No. 62/660,263, filed on Apr. 20, 2018.

(51) Int. Cl. G10D 3/16

(52) U.S. Cl. CPC G10D 3/163

(57) ABSTRACT

The present invention is a pick with a combination of features to create different effects and sounds with one single pick and gripping features.

This application claims priority to U.S. Provisional application 62/660,263 filed on 20 Apr. 2018, the entire disclosure of which is incorporated by reference.

### BACKGROUND OF THE INVENTION

### Field of the Invention

The present invention is in the field of guitar accessories. More specifically, the present invention is an attack effect guitar pick or multi effect pick with grip.

### Background of the Invention

The present invention is combination pick with features to create different effects and sounds with one single pick and gripping. The present invention is an attack effect guitar pick or multi effect pick with grip with a broad tip and focused tip located near the top of attack effect guitar pick. The broad tip and focused tip may be combined to make a twelve-string attack effect. A standard 351 style tip is located at a bottom of attack effect guitar pick. A graduated multi tooth is for a twelve-string strum effect and is located on the same side as the focused tip. The side the opposite graduated multi tooth is jazz tip located above indention for finger grip. The present invention saves money by having a multi features in one guitar pick. Also, a player can use the multi features to create new sounds by combining the features on the attack effect guitar pick to the guitar strings. In the competitive market of guitar picks having several features in one pick allows a competitive advantage by offering multiple features in one pick for one price avoiding players having to buy several picks. The music industry is very competitive and the next new sound is desirable. The present invention allows players to create new and unique novel sounds never before heard, by combining one of more features with gripping on my multi effects pick to the guitar strings making so many new sounds to win over the ears of record producers. In the competitive market of music coming up with a new sound can make or break a band or song my multi effects pick creates unique sounds giving a player the grip to create these unique sounds the player can combine the multi effects pick with grip features to make never heard before results. A player will gain speed and accuracy with my multi effect pick with grip because having all the valuable features in one pick allows the player to focus on creating the new sounds and not focusing on changing to a different pick, or to change instruments, during a performance making the player focused and lightning fast. A player can still use my attack effect guitar pick, or multi effect pick with grip, in typical fashion by using just the standard 351 style tip or jazz tip which allows a play the versatility to create new sounds and still make traditional sounds from one pick. Twelve-string guitars, add a very full sound, but they are very difficult to keep in tune, plus they are more difficult to play, as the guitarist must push down on 12 strings, versus 6, which takes more force. These instruments have the strings positioned in very close proximity to one another, which limits the ability to readily play single notes. There are rare, very expensive, and very heavy, dual neck guitars, which integrate a twelve-string guitar neck, plus a six-string guitar neck, to be able to mix the twelve-string effect, along with single note play on the six-string neck. Even with such an impractical and expensive instrument, switching back and forth is disruptive to the flow of the song. The multi effect pick can accomplish both with a quick re-positioning of the pick, or re-positioning of the hand, to utilize the individual features of the multi pick. The graduated multi tooth feature provides both a progressive crescendo effect, or can be reversed for a declination diminuendo effect.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a attack effect guitar pick or multi effect pick with grip, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

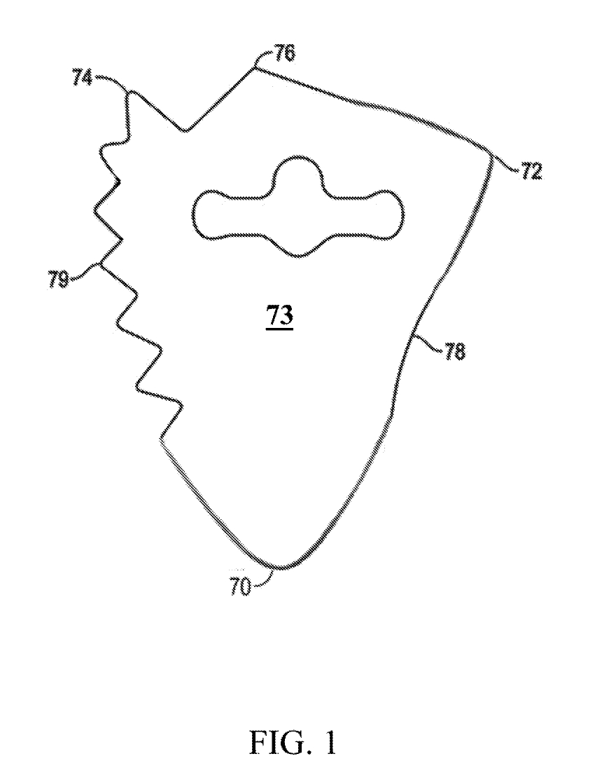

Referring now to FIG. 1, illustrated is an attack effect guitar pick, in accordance with one embodiment of the present invention. In FIG. 1, illustrated is an attack effect guitar pick 73. Shown are broad tip 76 and focused tip 74 located near the top of attack effect guitar pick 73 broad tip 76 and focused tip 74 may be combined to make a twelve-string attach effect. A standard 351 style tip 70 is located at a bottom of attack effect guitar pick 73. A graduated multi tooth 79 is for a twelve-string strum effect and is located on the same side as the focused tip 74. The side the opposite graduated multi tooth 79 is jazz tip 72 located above indention for finger grip 78.

While the present invention has been related in terms of the foregoing embodiments those skilled in the art will recognize that the invention is not limited to the embodiments described. The present invention may be practiced with modification and alteration within the spirit and scope of the appended claims. Thus, the description is to be regarded as illustrative instead of restrictive on the present invention.

What is claimed is:

1. A attack effect guitar pick comprising:
a broad tip and focused tip located near the top of the attack effect guitar pick the broad tip and the focused tip combine to make a twelve string attack effect, a standard 351 style tip is located at a bottom of the attack effect guitar pick, a graduated multi tooth for a twelve-string strum, crescendo or diminuendo effect, is located on the same side as the focused tip, the side the opposite graduated multi tooth is a jazz tip located above an indention for finger grip.

2. A pick comprising:
a multi effects pick with grip, the multi effects with grip has a broad tip and focused tip located near the top of the multi effects pick with grip the broad tip and focused tip combine to make a multi string attack effect, a standard style tip is located at a bottom of the multi effects pick with grip, a graduated multi tooth for a crescendo or diminuendo effect string strum effect, is located on the same side as the focused tip, on the side opposite the graduated multi tooth is a jazz tip located above an indention for finger grip.

3. The pick of claim 2 wherein the multi string attack effect is a twelve-string attack effect.

4. The pick of claim 2 wherein the standard style tip is a standard 351 style tip.

5. The pick of claim 2 wherein the crescendo or diminuendo effect string strum effect is a twelve-string strum effect.

6. A method for creating new sounds by a player comprising:
gripping by the player a multi effects pick with grip at an indention for finger grip, making a multi string attack effect with a broad tip and focused tip in combination the broad tip and focused tip located near the top of the multi effects pick with grip; and making a crescendo or diminuendo effect, string strum effect with a graduated multi tooth located on the same side as the focused tip.

7. The method of claim 6 wherein the multi string attack effect is a twelve-string attack effect.

8. The method of claim 6 wherein the string strum effect is a crescendo or diminuendo effect twelve-string strum effect.
